(19) United States
(12) Patent Application Publication
(10) Pub. No.: US 2005/0115149 A1
(43) Pub. Date: Jun. 2, 2005

(54) Device for adjusting water level

(76) Inventor: Hideho Tanaka, Aobaku Sendai City (JP)

Correspondence Address: DORSEY & WHITNEY LLP;INTELLECTUAL PROPERTY DEPARTMENT, 4 EMBARCADERO CENTER, SUITE 3400, SAN FRANCISCO, CA, 94111, US

(21) Appl. No.: 10/726,390

(22) Filed: Dec. 1, 2003

(51) Int. Cl. A01G 25/00

(52) U.S. Cl. 47/79

(57) ABSTRACT

A compact water level regulator which may be used with a water catcher and/or with a planter. A case includes side and upper surfaces of the case form an airtight chamber having an open bottom, a filling port plug, an air vent hole, and an air inlet in a side bottom. A first float is installed on the upper surface of the case and includes a ventilation plug. The ventilation plug releases and shuts the air vent hole as the first float raises and falls by the buoyancy thereof in response to the level of water outside the case. A second float is installed inside the case and includes a water filling port plug. The water filling port plug shuts the water filling port by buoyancy thereof in response to the water level inside the case. When water level falls enough to open the air inlet to the atmosphere, the second float falls thereby disengaging the water filling port plug and opening the water filling port.

### BACKGROUND OF THE INVENTION

1. Field of the Invention

This invention relates, in general, to a water level regulator for adjusting water level, a water-level-adjustable receiver or catcher, and a water-level-adjustable planter, and methods for their use.

2. Description of Related Art

There is an example of a water level regulator, such as the one found in the Official Report No. 8-500974. The device includes of the first flow controller which adjusts inflow of water to container by using a float, the second controller which adjusts flow of air to the first controller room by using a float, and the ventilation device which allows air flow into the first flow controller room. When the water level in the container falls below a prescribed position, water is permitted to flow in, giving suitable amount of water for the growth of the plant.

The past water level regulator includes of the first and the second flow controllers each of which must be encased individually. Such system could become too large in size.

What is needed is a water level regulator, water catcher and planter that are compact in size and overcome the above and other disadvantages of known or past water level regulators.

### SUMMARY OF THE INVENTION

In summary, one aspect of the present invention is directed to a devise including a case, a first float and a second float.

The side surface and the upper surface of the case is shut to the airtight condition and the bottom side is kept open, which has a water filling port, an air vent hole and there is an air inlet at the lower part of the side surface.

The first float, which is installed in the upper part of the case, has the air ventilation plug, through which the first float moves up and down by the buoyancy of the water and its own weight. When the water level in the case exceeds the first prescribed water level; the air ventilation plug releases the air vent hole. If the water level falls below the first prescribed level, the ventilation plug shuts the vent hole.

The second float, which is installed inside the case, has the filling port plug through which the second float moves up and down by the buoyancy of the water and its own weight. When the water level in the case exceeds the second prescribed water level that is higher than the first water level, the filling port plug s the filling port. When the air inside the case is decompressed, the filling port plug keeps the filling port shut. When the water level is such that it allows the air inlet to lead to the atmosphere, the water filling port plug releases the water filling port. These are the features of the water level regulator.

The water level regulator, which concerns this invention, is installed at the bottom of the water catcher. The water filling port is connected to the water storage tank, which is positioned higher than the water filling port. The planter should be placed above the water catcher. If the water is less in the water catcher, the second float goes downward, the water filling port plug releases the water filling port. Therefore, the water is given to the inside of the case and the water accumulates. The water level goes up in the case; the buoyancy lifts the second float. When the water level exceeds the prescribed first water level, the buoyancy lifts the first float the air ventilation plug releases the vent hole. Therefore, it makes easier the water to enter the case. The water level exceeds the prescribed second water level, the water filling port plug to the second float shuts the water filling port. The water stops to enter to the water catcher from the water filling port.

The water level in the case gradually decreases because of the absorbing by the plant and the evaporation.

The water level become less than the first prescribed water level, the first float goes downward by its own weight and the air ventilation plug to the case will shut the vent hole. Therefore, in case the water level in the case lowers, the second float will not decline. Because the inside case is in decompressed condition, the water filling port plug keeps the water filling port shut. In the event that the air inlet is made to lead to the atmosphere when the water level falls further, the second float declines by its own weight and the water filling port plug will release the water filling port. Accordingly, the water enters to the case from the water filling port, and the water accumulates in the water catcher. Thereby, the level adjustment is made possible.

The device can be miniaturized because the case, the first float and the second float can easily separate this water level regulator.

The water level regulator, which concerns this invention, the case has the water filling port in the side of the body and the air vent hole in upper surface. The first float that is able to move vertically is located on the case. The second float that is able to move vertically is located inside the case. These are the favorable fact for this device.

The water-level-adjustable water catcher, which concerns this invention, includes of the main body of the water catcher and the water level regulator. Planter installation part is located on the upper surface of the water level regulator. The water level regulator is installed at the bottom inside the water catcher.

The water-level-adjustable water catcher, which concerns this invention, can be used by connecting the water filling port of the water level regulator to the water tank placed at a higher position. The planter is placed on the water catcher. The water level regulator supplied the water into the water catcher and adjusts the water level insides.

The water-level-adjustable water catcher, which concerns this invention, includes of the water catcher, water absorption mat and the water level regulator. The water catcher has a groove on the upper side. The water absorption mat is laid on top of the water catcher. There is a water suction part inside the water catcher, which is inserted through the groove. The water level regulator is placed inside at the bottom of the water catcher. These are the features of this device.

With this water-level-adjustable water catcher, the water filling port of the device is connected to the water tank set at a higher place. The planter is placed on the water absorption mat. The water level regulator supplies water into the water catcher and adjust the water level. The water absorption mat absorbs the water from the water catcher via the groove from the water inlet part. The plants will consume the water absorb through the water absorption mat.

The water-level-adjustable water catcher holds the flowerpot. The planter is placed on the water absorption mat, which is made of boded close. It is desirable to be laid on top of the water absorption mat. In this case, the flowerpot absorbs the water through the bottom part from the water absorption mat. The breathable flowerpot could absorb the air from the atmosphere.

The water-level-adjustable planter, which concerns this invention, it includes of its body and the water level regulator. The planter body has an installation part in the sidewall. It is the feature of this device that the water level regulator is located inside bottom of the planter body.

The water-level-adjustable planter, which concerns this invention, it can be installed on the building wall. The water filling port should be connected with the water tank at a higher position. The water level regulator will supply the water and also adjust water level inside the planter.

The water-level-adjustable planter, which concerns this invention, it includes of the water catcher, the sidewall. The top panel and previously described the water level regulator. The water catcher is water flow free and the partition is used to avoid penetrating the soil inside the device. The sidewall is located the surrounding area of the water catcher. The top panel is includes of hollow container installed the upper part of the sidewall.

The device includes of the water inlet in the upper part, the drainage in the side and the bottom part. There is a vertical penetrate hole for the plants located in the upper part of the one side of the pertained area. The water level regulator is placed at the bottom part of the water catcher in the other side of pertained area. The water filling port is connected to the drainage. These are the feature of this device.

This water-level-adjustable planter includes of the penetrate hole for the plant in one side, the soil is placed in the container enclosed with the sidewall and the partitions and place the plant. The plant will grow through the hole toward upward. The rainwater run through the water inlet and accumulates inside the device. The water inside of the top panel brought in from the drainage is supplied into the planter and adjust the water level. The partition is placed one side of the water level regulator separated by the water and soil. The water is for the plant to grow.

The water-level-adjustable planter, which concerns this invention, includes of the water catcher, the water absorption mat for adsorbing the water inside of the water catcher that is located on the water catcher, the root proof mat that is located on the water absorption mat, the drain layer that is located on the root proof mat, the water storage layer that is located on the drain layer, the seed(s) that is sown on the water storage layer, the sunshade mat that is covering the seed(s), and the water level regulator, described above that is located inside the water catcher. Theses are the feature of the planter. This water-level-adjustable planter is suitable for growing non-flowering plants.

The device for adjusting water level, water-level-adjustable receiver or catcher, and water-level-adjustable planter of the present invention have other features and advantages which will be apparent from or are set forth in more detail in the accompanying drawings, which are incorporated in and form a part of this specification, and the following Detailed Description of the Invention, which together serve to explain the principles of the present invention.

### BRIEF DESCRIPTION OF THE DRAWINGS

FIG. 1 shows the cross-section diagram of the implementation of the invention for the water-level-adjustable water catcher that indicates irrigation condition.

FIG. 2 shows the cross-section diagram of the water level regulator at the irrigation halting condition on FIG. 1.

FIG. 3 shows the cross-section diagram of the water level regulator at immediately before irrigation on FIG. 1.

FIG. 4 illustrates the perspective view diagram of the water level regulator on FIG. 1.

FIG. 5 illustrates the exploded perspective view diagram of the water level regulator on FIG. 1.

FIG. 6 illustrates the exploded cross-section diagram of the water level regulator on FIG. 1.

FIG. 7 illustrates the perspective view diagram of the water level regulator in operation on FIG. 1.

FIG. 8 illustrates the perspective view diagram of the implementation of the invention for the water-level-adjustable water catcher.

FIG. 9 illustrates the perspective view diagram of another implementation of the invention for the water-level-adjustable water catcher.

FIG. 10 illustrates the perspective view diagram of the other implementation of the invention for the water-level-adjustable water catcher.

FIG. 11 illustrates the cross-section diagram of the water-level-adjustable water catcher on FIG. 10.

FIG. 12 illustrates the cross-section diagram of the implementation of the invention for the water-level-adjustable planter.

FIG. 13 illustrates the cross-section diagram of another implementation of the invention for the water-level-adjustable planter.

FIG. 14 illustrates the cross-section diagram of the implementation of the invention for the water-level-adjustable planter.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims.

The present invention has been described in Japanese Publication No. 2002-345342 published Dec. 3, 2002, the entire content of which publication is incorporated herein and affixed hereto as Appendix A. An English-language translation thereof is affixed hereto as Appendix B, the entire content of which translation is also incorporated herein.

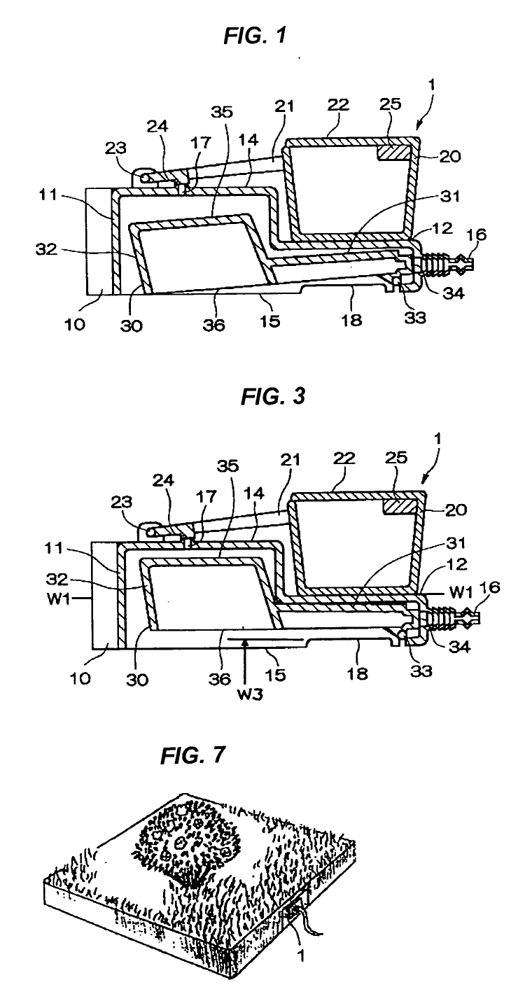

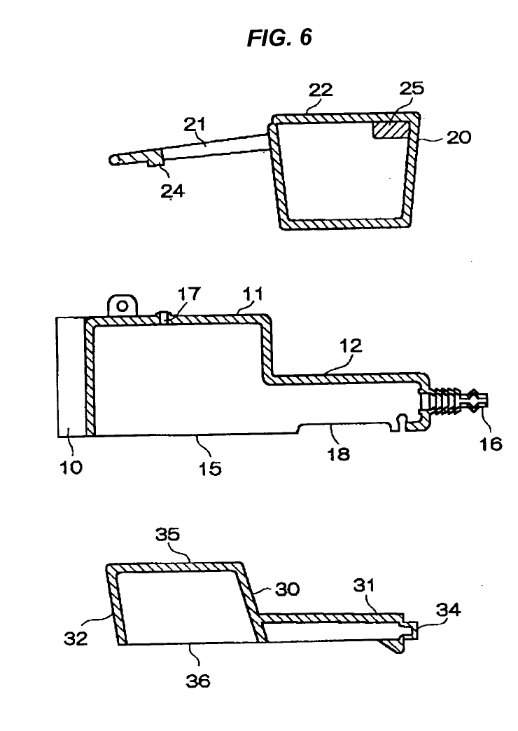

FIGS. 1 to 9 illustrate one implementation of the invention. FIGS. 1 to 6 illustrate a water level regulator 1 including a case 10, a first float 20 and a second float 30. Case 10 integrates a cabinet part 11 and a container part 12.

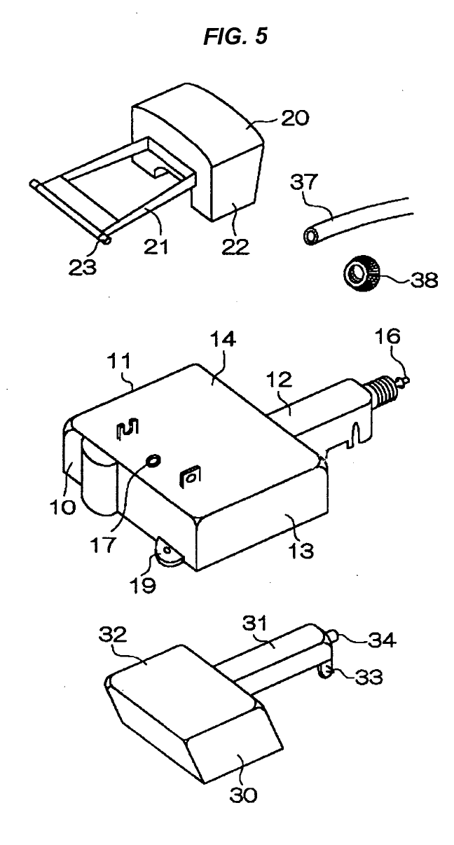

The side panel 13 upper surfaces 14 are closed airtight and the bottom panel 15 is open. FIG. 5 illustrates the lever storage 12 is thinner in thickness and flatter than the cabinet part 11 without the bump. The case 10 has the water filling port 16 at the edge of the lever storage 12. The case 10 has the air vent hole 17 on the upper surface of the cabinet part. FIGS. 1 to 3 show the case 10 has the inlet 18 extended along the lower side panel of lever storage 12. The optimal height for the inlet 18 is 2-3 mm. The case 10 has the protruding part 19 at the lower section. The protruding part 19 is provided for the screw hole for fixation.

First float 20 integrates with the lever 21 and float portion 22. The rotational lever 21 is installed at the upper protruding part on the cabinet part 11 at the spindle part 23. The lever 21 holds the air ventilation plug 24 located in the lower air vent hole 17. The air ventilation plug 24 is made of flexible material. The float portion 22 is built at the other-edge of the lever 21 and placed on the lever storage part. Inside the float portion 22 holds the weight 25. The first float 20 is heavier than the second float 30. The float portion 22 of the first float 20 moves around the axis 23 by the buoyancy and by its own weight. The first float makes a move when the water level in the case 10 exceeds the prescribed first water level of W1 (FIG. 3). The air ventilation plug 24 releases the air vent hole 17 when the float portion 22 goes upward by the buoyancy. The air ventilation plug 24 shuts the vent hole 17 when the water level is below the first water level W1.

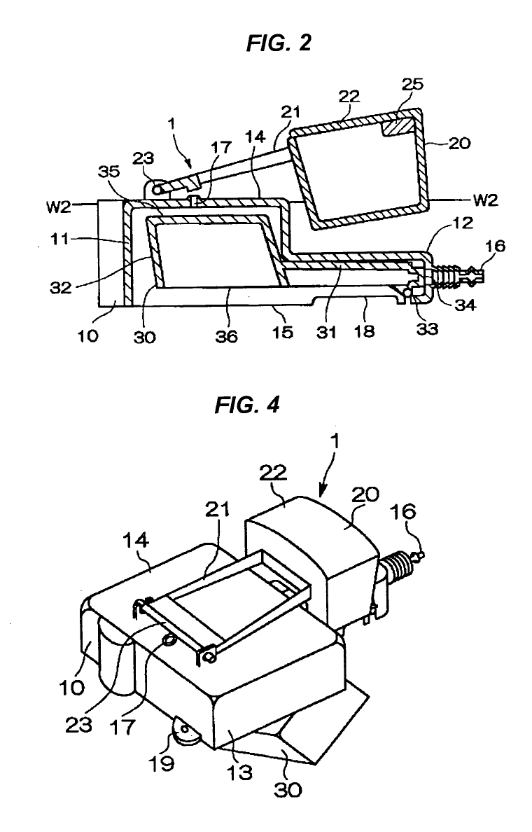

Second float 30 integrates with lever 31 and the float portion 32. The rotational lever 31 is installed on the lower edge of lever storage part 12 at the spindle part 33. The lever 31 holds the water filling port plug 34 located in the edge of the water-filling hole 16. The water-filling port plug 34 is made of flexible material. The float portion 32 is built on the other edge of lever 31 and placed in the cabinet part 11. The lever 31 and the float portion 32 close airtight to the side and upper panel, and the bottom portion 36 is open. The float portion 32 of the first float 30 moves around the axis 33 by the buoyancy and by its own weight. The second float makes a move when the first water level W1 (FIG. 3) in the case 10 exceeds the prescribed second water level of W2 (FIG. 2).

Water filling port plug 34 shuts the water filling port 16 when the float portion 22 goes upward by the buoyancy. When the case 10 is in decompressed state, the water filling port plug 34 keeps the water filling port 16 closed. When the water level falls sufficiently to allow air inlet 18 to open to the atmosphere (i.e., falls substantially below the level of a third prescribed water level W3), second float 30 drops thus causing water filling port plug 34 to release water filling port 16.

Water level regulator 1 is located within a water catcher 41 (e.g., a water-catching basin) on a bottom surface of the water catcher. The water filling port of the device is connected with the flexible tube 37 to a water source such as a water tank set at a higher position (FIG. 5). The water tank can be of any type of container as long as it can hold the water. The water filling port 16 has a protruding portion for fastening the flexible tube 37 so as to prevent disengaging of the tube or leaking of the water. The flexible tube 37 is fastened tightly to the water filling port 16 with the clasp 38.

The planter is set in the water catcher. If the water level in the water catcher is low, the second float goes downward by its own weight and the water filling port plug 34 releases the water filling port 16. Therefore, the water enters into the case 10 through the water filling port 16. The water is pooled in the water catcher. As the water level in the water catcher rises, the second float goes upward by the buoyancy. However, the air inside the case 10 would not be able to escape because the air vent plug 24 shuts the air vent hole 17. Consequently, the second float 30 does not go upward completely and the water filling port plug 34 is not able to shut the water filling port 16.

When the water level exceeds the first prescribed water level W1, The second float 20 rises with a little delay to the first float 30. The air ventilation plug releases the air vent hole 17 of the case 10. The built up compressed air coming into the case 10 through the air inlet goes off and it makes easier for the water to enter into the case 10. As the water level rises, the second float 30 raises more. When the water level exceeds the prescribed second water level W2, the second float 30 hits the roof panel of the case 10 and stops rising. At this time, the water filling port plug 34 of the second float 30 shuts the water filling port 16. The water stops flowing into the water catcher through the water filling port 16.

As the water stops flowing into the water catcher, the water inside the catcher starts to diminish due to capillary action of the plant roots touching the soil and evaporation. The water level in the case 10 gradually decreases. When the water level falls below the prescribed first water level W1, The first float 20 comes down by its own weight. The air ventilation plug 24 shuts the air vent hole 17 of the case 10. Therefore, even the water level in the case 10 falls, the case 10 becomes decompressed, keeping the second float 30 from coming down by its own weight. Thus the water filling port plug 34 keeps the water filling port 11 shut. The water level keeps falling and reaches the air inlet 18. This time, the water level is only 2-3 mm depth from the bottom of the water catcher. If the air inlet 18 lead to the atmosphere, the air gushes into the case 10 through the inlet 18 causing the second float 30 to come down by its own weight and the water filling port plug 34 release the water filling port 16. Once again, the water enters into the case 10 through the water filling port 16 and the water starts pooling. The water level is adjusted by repeating this operation.

The repetition of upward and downward movement of the water level is ideal for growing plants. The soil receives constant supply of water and air interchangeably, which activates the microorganism to breakdown organic substances. Consequently, this enhances the taste of grown vegetables. The looping of the plants can be avoided. No stress created by the pouring water to the plants. The plants can have ideal growth cycle. It is now possible for plants to thrive even if the root doesn't expand as widely, thus the plant can be grown in smaller flower pots rather than conventional size pots.

Since water level regulator 1 is simply composed of case 10, first float 20 and second float 30, the device can stay small. Water level regulator 1 is operated by gravity with no power source required. Unless the device breaks down, it keeps adjusting water levels.

As shown in the FIG. 7, you may apply water level regulator 1 on the lawn, in bushes, plants in the rooftop, and the roadbeds.

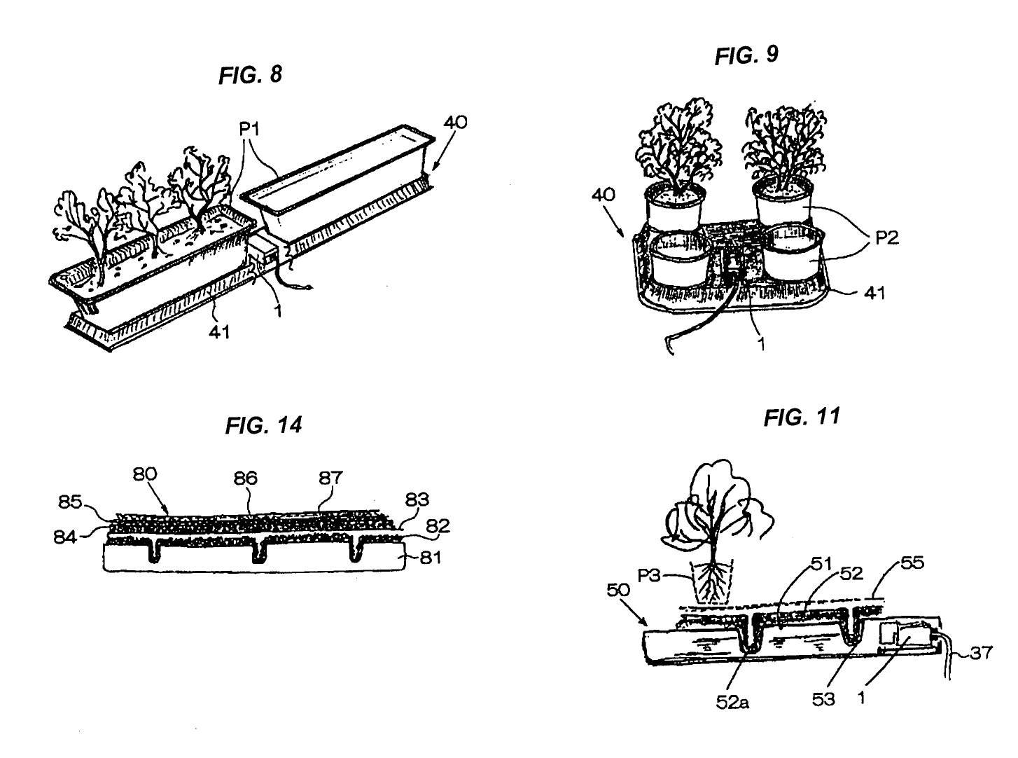

As an example of a water catcher 40 that is equipped with the water level regulator 1, FIGS. 8 and 9 show the combined use of water catcher 41 and water level regulator 1. Water catcher 41 has 2 or 4 planters P1, P2 installation parts on the upper part of the device. The water level regulator 1 is located inside water catcher 41.

Water-level-adjustable water catcher 40 can be used as water filling port 16 of water level regulator 1 is connected with the water tank at a higher place (no figure shown). The rainwater can be stored in the water reserve tank. The fertilizer supply line can be installed in connected route between water filling port 16 and the water reserve tank. Instead of connecting water filling port 16 to the water reserve tank, it can be connected to the water faucet by using decompression device. Planters P1 and P2 are placed on water catcher 41. The planter can be any size or any form. The water level regulator 1 supplies the water and adjusts the water level to inside water catcher 40.

The water-level-adjustable water catcher 40 can be used for profit-pursuing purpose. For example, to grow flowers, trees, vegetables for profit-pursuing purposes, this device can be combined with solar panels, dry batteries, 12V/4 A motors, water catch tanks, pressure tanks, fertilize devices and/or EC/FC meters. It is capable to cultivate 2000 pots of tomato, melons etc. in 1000 sq. meters. The water-level-adjustable water catcher 40 is applicable in all types of planters such as cartridge type plants, planters for flowerpots, cartridge type planters for vegetable grow (round, square, any shape), and planters for foliage plants.

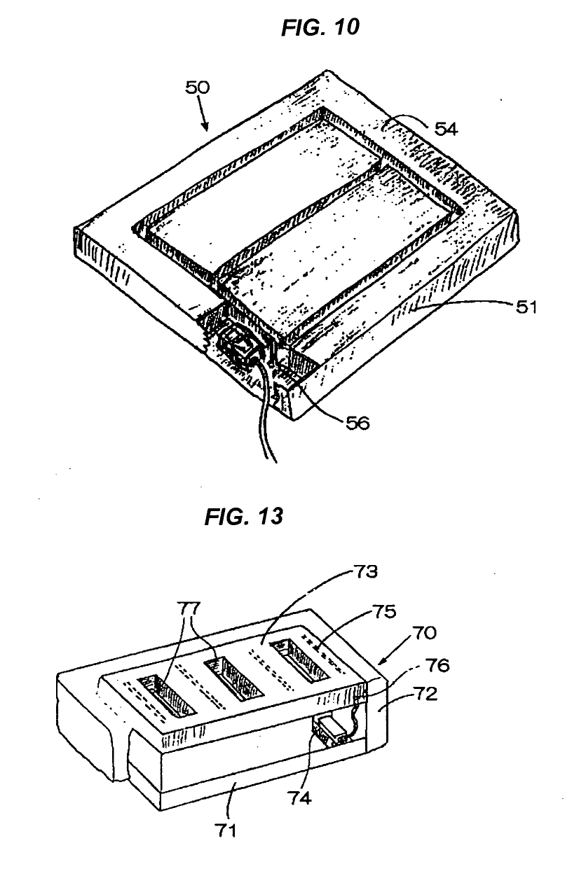

FIG. 10 and FIG. 11 illustrate a different approach to the implementation of the invention for the water-level-adjustable water catcher.

The water-level-adjustable water catcher 50 includes a water catcher 51, a water absorption mat and a water level regulator.

Water catcher 51 includes of an upper surface 54 with a groove 53. Water absorption mat 52 is located on upper surface 54 of water catcher 51.

There is the water intake 52a inserted through the groove 53 inside the water catcher 51. The thin roots proof mat 55 is located on the water absorption mat 52.

The water level regulator 1 is installed inside at the bottom of the water catcher 51, which leads to the groove 53.

The water-level-adjustable water catcher 50 can be used by connecting the water filling port 16 of the device 1 to the water tank set at a higher place. The flowerpot P3 is set on the water absorption mat 52. The water level regulator 1 supplies the water into the water catcher 51 and adjust water level. The water absorption mat 52 sucks up water inside of the water catcher 51 from the water inlet 52a through the groove 53. The water seeps through the entire water absorption mat 52 through the capillary action. The water, sucked up by the water absorption mat 52, is supplied to the flowerpot P3.

Therefore, the water entered from the sluice through the flexible tube 37 run through the groove 53 and seep through the entire area. The flowerpot P3 is set on the roots proof mat. The flowerpot P3 is made of thin hemp like bonded textile, which is breathable. Consequently, the flowerpots can breath on a steady basis. Roots grow toward inside and do not appear outside.

The flowerpot P3 sucks up the water absorbed by the roots proof mat 55 from the bottom where the pot touches the roots proof mat 55. The plant in the pot takes in the water from the bottom of the pot. The water that the plant absorbed evaporates through the leaves. The plants roots supplied from the water intake 52a in the groove 53 absorbs the water in the water catcher 50 and the water level falls to the bottom. Then, the water absorption mat 52 is detached from the water and the air enters through the water absorption mat 52. At this time, the water flows out of the water reserve tank through the flexible tube 37 and flows into the water filling port 16. The water level regulator supplies water as previously explained and adjust the water level. These operations will be repeated depending on the needy condition of the plants. This eliminates water stress from the plants and also there will be ample supply of air entering the water absorption mat 52. The water-level-adjustable water catcher 50 is an ideal water supply system.

In case of producing plants, it is transplanted to a target place through production and growth planning from the seedling matching to the purpose of its use. In this case, “the procedure to grow the seedling is an important factor.” There is large variation on how the plants turn out depending on how they were grown, and, to some extent, depending on how they were maintained.

In general, the root looping is often seen at the stage of production of the sapling. This happens because even though, plants get sufficient water, they do not receive adequate amount of air at the production stage. Looping roots are not necessary for growth, and often need to be trimmed out before transplanting.

The following conditions are desirable during the production stage:
1. There is no looping of the root.
2. Sufficient water supplies; no need to extend root.
3. Sufficient air supplies at any time, no need to extend root.
4. The roots of the plant does not extend to the dry area but extend to wet area. The outside of the pot should be dried so as to let roots grow toward inside of the wet area. This way the root should be extending internally.

As a result, cutting out the root step can be skipped when transplanting the plants. The plants will grow steadily with minimum transplanting shock.

Even though all these problems have been known, there have not been effective ways to control plant production. Plant growers have never left the conventional practice of pouring water to plant pots all at once because of practicality from the standpoint of growers. This water-level-adjustable water catcher 50 makes a good environment for the plant from the synergy effect of the water level regulator 1 and the water absorption mat 52. It could lead to the desirable economic effect.

In the past, many hard to grow plants were force-grown in a short term. All means were used to improve the profit. As a result, the deterioration of a vast environment was caused. As putting manure directly, the chemical fertilizer that dissolves to water is given, and then it begins to melt when it gives water. The effusing chemical reached the underground water from the bottom in the pot. Or, a liquid chemical fertilizer is mixed with the soil; the water was sprinkled on the soil for a long time. Meanwhile, far more a large amount of chemical fertilizer mixed with water reached into the underground water and even reached to the sea. It is thought that it causes the red tide and other pollutions by eutrophication.

We should break out of such method. All the fertilizers are supplied for the plant. It is desirable that the plant absorbs everything. The fertilizer should not infiltrate into the soil with water. If the water-level-adjustable water catcher 50 is used, the production system that can disseminate fertilizer only to the plants without any spilling can be established. This is highly desirable for preserving the environment.

To set up one water level regulator in 1 sq. meter, one-hundred 9 cm diameter pots (3¾ inch diameter pots), eighteen 20 cm diameter pots (8 inch diameter pots) can be managed without manpower. Because of shortage of young age labors in this field, this would add to positive economic impact. Even within a 1000 square meter area, water management for a large quantity of plants can be possible without wasting even one drop of water without having to rely on much manpower

The conventional way of watering was to pressurized water and spray on the plants. Sometimes a massive amount of water is pumped in at once. Other times, plant pots are placed on water containing trays for water supply and the water is drained afterwards or the chemical substance and the chemical fertilizer for disinfectant and sterilization are mixed in water and sprinkled. Most of the supplied water infiltrates into the soil. Such water management is practiced repeatedly. Such is the realistic picture in the plant production world and, while some people question the conventional way of water management, not much has been done to address the problem.

The water-level-adjustable water catcher 50 has made it possible to control once thought of as uncontrollable factors like the water saving, fertilizer saving and chemical saving. Other benefits include no more polluted underground water, creating ideal ecological condition for plants to grow, saving the labor costs and achieving overall cost savings. This means that it is not only good from the environmental standpoint, but also adds significant economic benefits. A big improvement is brought to the plant growing practice by combining the water level regulator 1 and the pot made of the bonded textile P3 with water absorption mat 52.

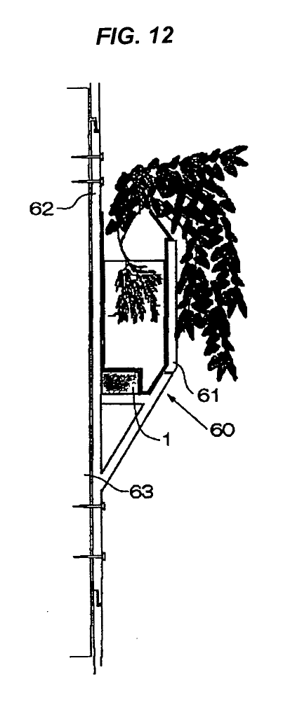

FIG. 12 shows the implementation of the invention of the water-level-adjustable planter. Water-level-adjustable planter 60 includes planter body 61 and water level regulator 1. Planter body 61 has installation part 62 in the back panel for the installation on the wall. The water level regulator 1 is placed inside the bottom of the planter body 61. The water level regulator 1 is installed in the planting part and the room for easy maintenance. The water level regulator 1 is detachable for easy maintenance to the plants.

In using water-level-adjustable planter 60, part 62 of planter body 61 is mounted to a wall surface 63. Water filling port 16 of the water level regulator is connected with the water tank set at a higher position. Water level regulator 1 supplies the water into the planter body 61 and adjusts the water level.

The water distribution system of the water level regulator can supply the water and the air regularly and repeatedly. In this way, plants always receive what it needs the most. Therefore, no more water stress exists for all types of plants. On the other hand, water management by human hand is hard and sometimes impossible to manage. The human developed good use of technology such as computer sensor, which is able to detect things that the human is unable to find. The human tend to depend on the electric method. However, the complicate system such as the electric wiring is very vulnerable to the water.

It makes system even more complicated and hard for the maintenance.

The water level regulator 1 does not include of any electric parts. It utilizes only the force of gravity. As for the water level regulator 1, the structure is extremely simple; therefore the breakdown is very rare. If this simple device, the water level regulator 1 is installed to the buildings and the building walls, the buildings can be covered with plenty of greeneries. In that case, the positive impact on the global environment is immeasurable.

To install the device on the wall, the following matters and measures must be considered:
1. As measures against climate changes, the plant that can adjust to the climate should be selected.
2. As measure against changes of sunshine amount, the plants should be selected according to the region (Japan's case for example, east part or west part of Japan).
3. As the measures against the amount of rainfall, when the rainfall exceeds a certain amount, let it be overflow.
4. As measure against changes of sunshine duration, the plants should be selected according to the region.
5. As measure against changes of the seasons, Plans in spring through autumn and plans in autumn through winter should be selected.
6. As measure against changes of the force of the wind, it should be protected it from the strong wind with the net.
7. As measure against changes of wind direction, the plans should be stable against the strong wind and it is necessary to add the reinforcement work.

By conducting these measures, water-level-adjustable planter 60 is able to deal with all types of weathers. Accordingly, by placing water-level-adjustable planter 60, Greening can be offered to the buildings of the cities without green. Water-level-adjustable planter 60 can be installed to the wall by screwing regardless of new or already existing buildings.

By greening the walls and buildings, it is possible greening the whole building.

Incidentally, Greening can protect the wall materials and the waterproof layers, which leads to extending its useful life.

Accordingly, it will not be necessary to use bricks, ceramics and expensive tiles to construct buildings. Relief of heat Island environment, creating comfortable city environment, protecting earth environment can be achieved. Any types of plants can be planted for greening project. In general speaking, planting low maintenance perennials are desirable. Accordingly, a law maintenance type greening system that makes the best use of natural environment can be constructed. The energy cost saving from reduced air conditioning bill can be expected because the rise of the outside temperature through heat evaporation can be minimized. Furthermore, accumulation of the raindrops from the plants, the outflow of surplus water can be delayed to prevent city type flooding. The plants can absorb not only the water but also the dust in the air and noise. Also, water-level-adjustable planter 60 can install the guards to protect the plans from the strong wind.

FIG. 13 shows the implementation of the invention of the water-level-adjustable planter.

The water-level-adjustable planter 70 includes a water catcher 71, a sidewall 72, a top panel 73 and the water level regulator.

Water-level-adjustable planter 70 is rectangular in shape. There is a partition 74 able to pass water and to prevent the soil. The sidewall 72 is installed in the surrounding area of the water catcher 71. The top panel has a lot of water inlets on the upper part and drainage in the bottom.

A top panel 73 has penetration holes 77 for plant to grow vertically above one side while partitioned by a partition panel 74. Water level regulator 1 is installed on the other side of partition 74 by the inside on the bottoms of water catcher 71. Water filling port 16 of water level regulator 1 is connecting to the drainage with the flexible tube.

Water-level-adjustable planter 70 has top panel 73 and penetration hole 77. On the other side, the soil is placed on the water catcher 71 enclosed with sidewall 72 and the partition 74, and then plants are planted. The plant is made to grow from penetration hole 77 to upward.

The rainfall enters from top panel 73 a water inlet 75, and accumulates inside the device. The water in top panel 73 is taken from a drainage 76, and water level regulator 1 supplies into the planter and adjusts the water level. Partition 74 passes water located on the opposite side of water level regulator 1 to the other side. The water is to be used by the plants.

The following is the features of the water-level-adjustable planter:
1. The rainwater can be accumulated.
2. To pool the rainwater, the container is needed. Top panel 73 can be a container.
3. Top panel 73 can only accumulate rainwater. Top panel 73 should be inclined.
4. Inside the container should need inclination.
5. There is certain capacity in top panel 73. It will not hold more than its capacity.
6. If there is more rainfall, the rainwater will enter into penetration hole 77.
7. Plants are planted from penetration hole 77 of top panel 73.
8. Or, cover with top panel 73 so that the plant is exceeded from penetration hole 77 after planting.
9. To make things easier to plant from penetration hole 77, the size of penetration hole 77 is 10.5 cm wide that your palm can be passed through the hole.
10. The top panel is (1) protecting inflow of the soil by heavy rain, (2) protecting soil to become consolidated from heavy rain, and (3) in case of heavy rain, because the rain water that entered from 77 is gone along in the leaf and enters, the influence of rain of the soil is considerably little. So, it protects soil to become consolidated.
11. By having the top panel, rising temperature of the soil surface can be controlled by strong sunbeam.
12. Under top panel 73, the top panel protects the plant root that is growing. Because of this, mulching-agent is not needed.
13. Penetration hole 77 of the top panel can hold large sized pots currently used for flowering plants.
14. Penetration hole 77 of top panel 73 can somehow hold pot mums in 12 cm diameter pots. There is no problem with small prude mum.
18. Seeds of weeds in the soil would not germinate because top panel 73 closes off from it.
19. In case seed in the soil germinate afterwards, top panel 73 shuts off the sun, and then weeds will not grow normal.
20. In case weeds germinate in between plants, it is easy to pull out them from the soft soil.
21. Seeds of weeds germinated later on, it is also easy to pull out.
22. Accumulated rainwater in top panel 73 stops water to enter at certain water level.
23. Water level regulator 1 adjusts water level by the force of gravity.
24. The water entered in water level regulator 1 stops entering at certain water level.
25. Rainwater absorbed in the soil is absorbed by the plants. The rainwater is kept in certain level and contacting with soil, it is absorbed in the soil by the capillary action.
26. The moisture that the plant breathed in begins the transpiring action by the sunlight.
27. The moisture the most important for the plants is abundantly supplied always if necessary without the excess and deficiency. The water stress that is powerful enemy no longer exists.
28. The necessary fertilizer flows in at the same time, so that plants grow well.
29. Water level regulator 1 can also supply the air (e.g., oxygen). The water and the air are supplied alternatively. The cycle of repetition of the water, supply is given as needed for each pots even though the environmental variables like weather, temperature, season, wind force, sunlight time, humidity in the air, sunshiny and shade, type of plants, grow speed of plants, size of plants, etc. exist. Water-level-adjustable planter 70 provides ideal device for plants growth. The blind spots of the cultivation of the flower and the plant that the human could not have done manually is solved. This is the best device for plants.
30. The plant does not need to put the root more than necessary. No looping is necessary, (e.g., the root twined in the pot when the root grows for water and nourishment). For example, a white root twines when the flower is pulled out from the pot.
31. This is an extremely desirable condition for plants to grow. The plants can keep growing without transplantation.
32. It is surprising how little of rooting is required considering the size of planted area and the size of the plants. No need to add an extra soil. No need to use larger size planting pots. The benefit is significant from the viewpoint of the costs, economy, weight and resources.
33. The surrounded pot is made mixing with remaining clay, slaked lime, and water according to a traditional Japanese method (e.g., the Tataki method).
34. Since the environmental preservation has been stressed globally, CO2 is absorbed into “tataki” during the manufacturing process. The environment friendly plants are planted by using natural substance and eco-friendly materials.
35. By pool the rainwater temporarily, these plants contributes to easing the city type flood.
36. Since the heat Island phenomenon is becoming an issue of concern, greening is possible by utilizing rainwater on the man made pavement.
37. This device can be installed at any places (e.g., places where it rains a lot). In case, it lacks of rainwater, hand watering with bucket of water would do.
38. This device can be transformed into the water that does not oxidize by adding ferrous ferric chloride (FFC), and then it is transformed into the decay free rainwater.

FIG. 14 shows another implementation of the invention of the water-level-adjustable planter. A water-level-adjustable planter 80 includes a water catcher 81, a water absorption mat 82, a root proof mat 83, a drainage layer 85, seeds 86, and a sunshade 87.

The water absorption mat is located on water catcher 81 that is able to absorb the water inside water catcher 81. The drainage 84 is placed on the root proof mat 83. The water reservation layer is made of the felt and is placed on drainage layer 84. The types of seeds grown 86 are moss and sedum and they are placed on water reservation layer 85. Sunshade 87 is placed above seeds 86.

Water-level-adjustable planter 80 is for producing sedum necessary to turn the roof green. In recent years, there are amid calls for greening not only on the rooftops but also on the slanted rooftops as well. In city of Sendai, Tokyo and other local cities, government mandate greening of the rooftops by offering to subsidize the cost. And so, plants that thrive on the rooftop, and not the ground, i.e., sedum and moss type plants that can endure harsher rooftop conditions with minimum resources are raised on the rooftop garden. The rooftop condition would be created in such way that in case weeds intrude and germinate on the roof, weeds would wither out in dry climate and only sedum and moss, which can take dry climate much better, would survive. When growing sedum and moss, it is desirable to produce them on the ground under the same condition as the rooftop.

Water-level-adjustable planter 80 is the best for initial production of plants such as sedum. In the past, after setting up water-level-adjustable planter 80, sedum seeds are sowed. Environment similar to being on the rooftop, i.e., repeatedly dry ambience, is recreated. Though, young seeding needs the water, sedum is inept in humidity. The challenging task of timing when to add moderate humidity and dryness was only dependent on human touches and intuitions, and could not be automated. Water-level-adjustable planter 80 is the only device that can solve such problems.

While sowing sedum seeds may be an easy task. Taking care sedum after germination is hard because sedum is delicate. Hand-watering is especially hard. When water-level-adjustable planter 80 and water level regulator 1 are used together, the water level can be adjusted properly thus saving labor cost. Not only the healthy growth of sedum can be expected, but also they will be in much better condition to thrive and endure the much harsher condition once they are transferred to the roof.. Furthermore, if ferrous ferric chloride (FFC) usage is combined, the plant bed can become even stronger and disease-proof. Packaging grown sedum with the water supply layer makes shipping easier.

Related to this invention such as the water level regulator, the water adjustable water catcher, and the water adjustable planter by having simple structure make it possible for the device to stay small in size.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A water level regulator for adjusting water level comprising:
a case having a side and upper surfaces forming an airtight case chamber having an open bottom, a water filling port, an air vent hole and an air inlet having a height at a lower part of said side surface;
a first float mounted on said upper surface of said case for vertical movement by a first buoyancy thereof, said first float including a ventilation plug for closing said air vent hole when the water level falls below a first prescribed level (W1) and releasing said air vent hole when water level in said case exceeds said first prescribed water level; and
a second float mounted inside said case for vertical movement by a second buoyancy thereof, said second float including a filling port plug for shutting said water filling port when the water level in said case exceeds a second prescribed water level (W2) that is higher than said first water level (W1) and opening said filling port filling port when the water level falls approximately to said height of said air inlet and opens said case chamber to atmosphere.

2. A water level regulator according to claim 1, wherein filling port is located on a side of said case and said air vent hole is located on said upper surface of said case.

3. A water level regulator according to claim 1, wherein said water level regulator is mounted on a bottom surface of a water catcher and a plurality of planters are mounted on an upper part of said water catcher.

4. A water level regulator according to claim 1 in combination with a water catcher and a water absorption mat, wherein said water catcher includes a groove in an upper surface thereof and an absorption part on which said water absorption mat is arranged, said water level regulator being installed on an inside bottom of said water catcher.

5. A water level regulator according to claim 4 in combination with a flowerpot, wherein said water absorption mat is formed of a bonded textile and said flowerpot is set up on said water absorption mat.

6. A water level regulator according to claim 1 in combination with a planter body, said planter including a sidewall and an inside bottom, wherein said water level regulator is installed on inside bottom of said planter body.

7. A water level regulator according to claim 1 in combination with a water catcher, a sidewall, a top panel and planting soil, wherein said water regulator is mounted on a bottom surface of said water catcher and said water catcher includes a partition wall that is water permeable and separates planting soil from said water level regulator, said sidewall being installed outside of and surrounding said water catcher, said top panel positioned adjacent an upper part of said sidewall and being formed of a hollow container having water intake holes and drainage and plant holes allowing plants to grow vertically through said top panel, wherein said water filling port of said water level regulator is connected to said drainage of said top panel.

8. A water level regulator according to claim 1 in combination with a water catcher, a water absorption mat placed on said water catcher to absorb water inside said water catcher, a root proof mat that is located on said water absorption mat, a drain layer that is located on said root proof mat, a water storage layer that is located on said drain layer wherein seeds may be sown on said water storage layer, and a sunshade mat covering said water storage layer, wherein said water level regulator is located inside said water catcher.
